(19) United States
(12) Patent Application Publication
(10) Pub. No.: US 2025/0140280 A1
(43) Pub. Date: May 1, 2025

(54) VOICE PROCESSING DEVICE, VOICE PROCESSING METHOD, INFORMATION TERMINAL, INFORMATION PROCESSING DEVICE, AND COMPUTER PROGRAM

(71) Applicant: Sony Group Corporation, Tokyo (JP)

(72) Inventor: Naoya TAKAHASHI, Schlieren (CH)

(73) Assignee: Sony Group Corporation, Tokyo (JP)

(21) Appl. No.: 18/837,211

(22) PCT Filed: Jan. 6, 2023
(86) PCT No.: PCT/JP2023/000162

§ 371 Date: Aug. 9, 2024

(30) Foreign Application Priority Data
Mar. 4, 2022 (JP) 2022-033951

(51) Int. Cl. G10L 25/57

(52) U.S. Cl. CPC G10L 25/57

(57) ABSTRACT

A voice processing device that performs processing related to generation of a voice of an avatar image. The voice processing device includes: an extraction unit that extracts a feature value of an avatar image; and a processing unit that converts a voice quality of an input voice on the basis of the feature value in the feature value space or synthesizes a voice on the basis of the feature value in the feature value space. The extraction unit extracts the feature value of the avatar image by using a feature value extractor designed such that a feature value extracted from a voice and a feature value extracted from an avatar image created from a face image of a speaker who has uttered the voice share the same feature value space and are close feature values on the space.

### TECHNICAL FIELD

The technology disclosed in the present specification (hereinafter, “the present disclosure”) relates to a voice processing device and a voice processing method that perform processing related to generation of an avatar voice, an information terminal that performs an input operation for avatar voice processing, an information processing device that performs processing related to learning of a neural network model used for generation of an avatar voice, and a computer program.

### BACKGROUND ART

There are more opportunities to create and use an avatar of a person himself/herself in the metaverse (three-dimensional virtual space created by a computer) and the like. At present, regarding generation of an avatar image, there is a technology of allowing a user himself/herself to customize a preferred avatar image by selecting a hairstyle, a skin color, and a shape and size of parts of a face or automatically or semi-automatically creating an avatar image from a picture of the user's face. Meanwhile, regarding generation of an avatar voice, the user's voice is used as it is or is used only by changing frequency characteristics or performing a fixed filter processing such as a voice changer (see, for example, Patent Document 1), and it is difficult to customize a voice quality matching an impression of an avatar.

With recent development of voice processing technologies such as voice synthesis and voice quality conversion, it is possible to select a voice quality from among presets set in advance. However, creation of presets requires a large amount of voice data and costs much, and thus types are limited. Hence, it is difficult to prepare a large number of types unlike image customization. Therefore, the voice quality is likely to be the same as those of other people, and thus individuality of avatars is low. Further, even if a large number of presets can be prepared, it is difficult to intuitively customize the voice quality so as to match the avatar image.

### CITATION LIST

### Patent Document

PATENT DOCUMENT 1 Japanese Patent Application Laid-Open No. 2005-322125, paragraph 0073

### Non-Patent Document

Non-Patent Document 1: “Learning to Cartoonize Using White-box Cartoon Representations” CVPR 2020

### SUMMARY OF THE INVENTION

### Problems to be Solved by the Invention

An object of the present disclosure is to provide a voice processing device and a voice processing method that perform processing for generating a voice matching an impression of an avatar image, an information terminal that performs an input operation for processing of generating a voice matching an impression of an avatar image, an information processing device that performs processing related to learning of a neural network model used for processing of generating a voice matching an impression of an avatar image, and a computer program.

### Solutions to Problems

The present disclosure has been made in view of the above problems, and a first aspect thereof is
a voice processing device including:
an extraction unit that extracts a feature value of an avatar image; and
a processing unit that processes a voice uttered by the avatar image on the basis of the extracted feature value.

The extraction unit extracts the feature value of the avatar image by using a feature value extractor designed such that a feature value extracted from a voice and a feature value extracted from an avatar image created from a face image of a speaker who has uttered the voice share the same feature value space and are close feature values on the space. Alternatively, the extraction unit extracts the feature value of the avatar image by using a speaker feature value extractor designed such that a feature value extracted from a face image and a feature value extracted from an avatar image generated from the face image share the same feature value space and are close feature values on the space.

Then, the processing unit converts a voice quality of an input voice on the basis of the feature value in the feature value space or synthesizes a voice on the basis of the feature value in the feature value space.

Further, a second aspect of the present disclosure is
a voice processing method including:
an extraction step of extracting a feature value of an avatar image; and
a processing step of processing a voice uttered by the avatar image on the basis of the extracted feature value.

Further, a third aspect of the present disclosure is
an information terminal including:
a first input unit that inputs first data for creating an avatar image;
a second input unit that inputs second data for adjusting a voice of the avatar image; and
a processing unit that processes the voice of the avatar image on the basis of a feature value determined by using both a feature value extracted from the avatar image created on the basis of the first data and a feature value extracted from a voice of a speaker based on the second data.

Further, a fourth aspect of the present disclosure is
an information processing device including:
a first model that extracts a feature value of an avatar image;
a second model that converts a voice quality of a voice of the avatar image or performs voice synthesis on the basis of the feature value extracted by the first model; and
a learning unit that learns the first model and the second model by using a data set including at least two of a voice, a face image of a speaker who has uttered the voice, or an avatar image generated from the face image.

Further, a fifth aspect of the present disclosure is
a computer program written in a computer-readable format to cause a computer to function as:
an extraction unit that extracts a feature value of an avatar image; and
a processing unit that processes a voice uttered by the avatar image on the basis of the extracted feature value.

The computer program according to the fifth aspect of the present disclosure defines a computer program written in a computer-readable format so as to implement predetermined processing in a computer. In other words, by installing the computer program according to the fifth aspect of the present disclosure in a computer, a cooperative action is exerted in the computer, and effects similar to those produced by the voice processing device according to the first aspect of the present disclosure can be obtained.

### Effects of the Invention

According to the present disclosure, it is possible to provide a voice processing device and a voice processing method that converts a voice quality of a user's voice into a voice quality matching an impression of an avatar image or synthesizes a voice matching the impression of the avatar image without requiring voice data paired with an avatar even for an unknown avatar image, an information terminal that performs an input operation for processing of generating a voice matching an impression of an avatar image, an information processing device that performs processing related to learning of a neural network model used for processing of generating a voice matching an impression of an avatar image, and a computer program.

Note that the effects described in the present specification are merely examples, and the effects produced by the present disclosure are not limited thereto. Further, the present disclosure may further produce additional effects in addition to the effects described above.

Still other objects, features, and advantages of the present disclosure will become apparent from a more detailed description based on embodiments as described later and the accompanying drawings.

### BRIEF DESCRIPTION OF DRAWINGS

FIG. 1 shows a functional configuration of a voice quality conversion device 100.

FIG. 2 shows a functional configuration of a learning system 200 based on a design method (1).

FIG. 3 shows a functional configuration of a learning system 300 based on a design method (2).

FIG. 4 shows a functional configuration of a voice synthesis device 400.

FIG. 5 shows a functional configuration of a learning system 500.

FIG. 6 shows a configuration example of a UI screen for adjusting voice quality conversion processing of a voice of an avatar.

FIG. 7 shows another configuration example of the UI screen for adjusting voice quality conversion processing of a voice of an avatar.

FIG. 8 shows an implementation example of the present disclosure.

FIG. 9 shows a configuration example of a GAN.

### MODE FOR CARRYING OUT THE INVENTION

Hereinafter, the present disclosure will be described in the following order with reference to the drawings.
A. Overview
B. Voice quality conversion
B-1. Configuration of voice quality conversion device
B-2. Method (1) of designing speaker feature value extractor and voice quality converter
B-2-1: At the time of learning
B-2-2: At the time of inference
B-3. Method (2) of designing speaker feature value extractor and voice quality converter
B-4. Mixing of original speaker feature value
C. Voice synthesis
C-1. Configuration of voice synthesis device
C-2. Method of designing speaker feature value extractor and voice synthesizer
D. Tools

### A. Overview

There are more opportunities to create and use an avatar of a person himself/herself in the metaverse and the like. There are already many technologies related to generation of an avatar image, but, regarding generation of an avatar voice, it is difficult to intuitively customize a voice quality so as to match an avatar image. In the voice processing technology that has been developed in recent years, a voice quality can be selected from among presets set in advance. However, creation of presets requires a large amount of voice data and costs much, and thus types are limited. Therefore, it is difficult to express individuality.

Meanwhile, the present disclosure is a technology of converting a user's voice into a voice quality matching an impression of an avatar image without requiring voice data paired with an avatar even for an unknown avatar image that is not included when voice quality conversion is designed.

Further, the present disclosure is a technology of synthesizing a voice matching an impression of an avatar image without requiring voice data paired with an avatar even for an unknown avatar image that is not included when voice synthesis is designed.

### B. Voice Quality Conversion

In this section B, voice quality conversion processing of converting a user's voice into a voice quality matching an impression of an avatar image according to the present disclosure will be described.

### B-1. Configuration of Voice Quality Conversion Device

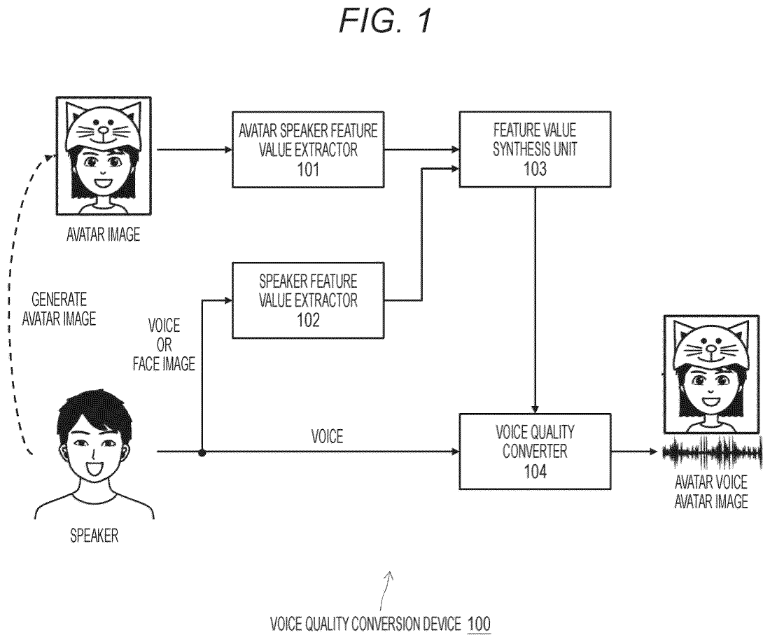

FIG. 1 schematically shows a functional configuration of a voice quality conversion device 100 that converts a voice uttered by a speaker into a voice quality matching an impression of an avatar image of the speaker by applying the present disclosure. The voice quality conversion device 100 in FIG. 1 includes an avatar speaker feature value extractor 101 and a voice quality converter 104 as basic components.

The avatar speaker feature value extractor 101 extracts a speaker feature value from an input avatar image. The “speaker feature value” mentioned in the present specification is a feature value that characterizes a voice quality of a speaker (the same applies hereinafter). Note that the avatar image may be automatically generated by a predetermined converter (not shown in FIG. 1) on the basis of a face image or other pieces of information of the speaker or may be manually edited by the speaker or another person (in short, the avatar image may be unknown when the voice quality conversion device 100 is designed). Then, the voice quality converter 104 converts a voice uttered by the speaker into an avatar voice having a voice quality matching an impression of the avatar image on the basis of the speaker feature value extracted by the avatar speaker feature value extractor 101 from the avatar image.

Further, the voice quality conversion device 100 in FIG. 1 may further optionally include a speaker feature value extractor 102 and a feature value synthesis unit 103.

The speaker feature value extractor 102 extracts a speaker feature value from at least one of the face image of the speaker or the voice of the speaker. Note that the speaker feature value extracted by the speaker feature value extractor 102 from the face image or voice of the speaker shares the same space (speaker feature value space) with the speaker feature value extracted by the avatar speaker feature value extractor 101 from the avatar image. The feature value synthesis unit 103 mixes the speaker feature value extracted by the speaker feature value extractor 102 from the face image or voice of the speaker with the speaker feature value extracted by the avatar speaker feature value extractor 101 from the avatar image. A mixing ratio thereof may be a fixed value set by default or may be a value freely set by a user such as a speaker. Then, the voice quality converter 104 converts a voice quality of the voice uttered by the speaker on the basis of the synthesized speaker feature value. When the mixing ratio of the speaker feature value extracted by the speaker feature value extractor 102 is increased in the feature value synthesis unit 103, a voice of the avatar image can be closer to the voice quality actually uttered by the speaker (voice quality having an impression given from the image of the speaker).

Among the components of the voice quality conversion device 100 in FIG. 1, the avatar speaker feature value extractor 101, the speaker feature value extractor 102, and the voice quality converter 104 are each implemented through statistical learning processing by using a deep neural network (DNN) technology, and the details thereof will be described in the following section B-2.

### B-2. Method (1) of Designing Speaker Feature Value Extractor and Voice Quality Converter

In this section B-2, a method of designing DNN models used for the speaker feature value extractor 101 and the voice quality converter 104 of the voice quality conversion device 100 in FIG. 1 will be described.

### B-2-1: At the Time of Learning

Generally, high-quality voice quality conversion is frequently implemented by statistical learning using a large amount of data by using the DNN. Meanwhile, avatar images are frequently designed separately from voices, and thus it is difficult to acquire a large amount of voice data paired with the avatar images. Therefore, the present embodiment learns DNN models configuring the speaker feature value extractor (the avatar speaker feature value extractor 101 and the speaker feature value extractor 102 in FIG. 1) and the voice quality converter (the voice quality converter 104 in FIG. 1) by using a technology of creating an avatar image from a face image.

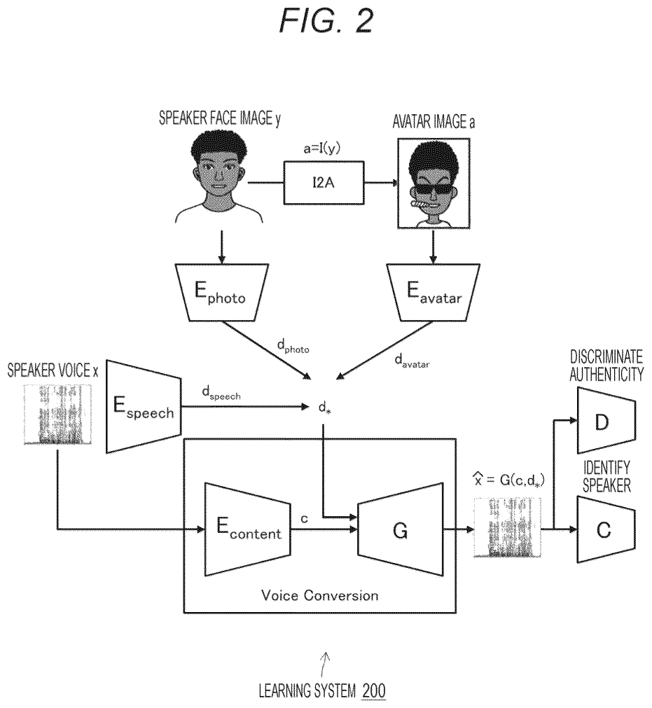

FIG. 2 shows a functional configuration of a learning system 200 for learning DNN models used as the speaker feature value extractor and the voice quality converter in the voice quality conversion device 100.

First, each component in the learning system 200 will be described.

Image to Avatar (I2A) is a converter that converts a face image y of a speaker into an avatar image a of the speaker. Therefore, the converter I2A can be expressed as a function a=I(y).

E_{speech} represents an encoder that extracts a speaker feature value d_{speech} from a voice x uttered by the speaker and can be expressed as a function E_{speech}(x)=d_{speech}. Further, Eₚₕₒₜₒ represents an encoder that extracts a speaker feature value dₚₕₒₜₒ from the face image y of the speaker and can be expressed as a function Eₚₕₒₜₒ(y)=dₚₕₒₜₒ. Furthermore, Eₐᵥₐₜₐᵣ represents an encoder (avatar encoder) that extracts a speaker feature value dₐᵥₐₜₐᵣ from the avatar image a and can be expressed as a function Eₐᵥₐₜₐᵣ(a)=dₐᵥₐₜₐᵣ.

E_{content} represents a content encoder that extracts a feature value depending on utterance content but not depending on the speaker from the voice x uttered by the speaker and can be expressed as a function c=E_{content}(x). For example, E_{content} can use output of a voice recognizer. The feature value c may include volume and pitch information.

A decoder G receives input of the feature value c of the voice not depending on the speaker and a speaker feature value d* extracted from any one of the above encoders E_{speech}, Eₚₕₒₜₒ, and Eₐᵥₐₜₐᵣ and outputs a voice. The output of the decoder G is represented as G(c, d*). Note that the subscript * of d represents any one of speech, photo, and avatar. Further, in FIG. 2, the output of the decoder G is represented by adding a symbol “\hat{ }” above the letter “x” representing the voice of the speaker. Hereinafter, the letter x representing the variable with the symbol “\hat{ }” thereabove represents an estimated value or predicted value of the variable x. Further, in the present specification, the estimated value or predicted value of the variable x is represented as “x\hat{ }” by connecting the letter “x” and the symbol “\hat{ }”.

Two discriminators D and C are introduced into the learning system 200. D represents a discriminator that discriminates whether the voice x\hat{ } generated by the decoder G is an authentic voice or a voice generated by the decoder G. Further, C represents a speaker discriminator that identifies a speaker of the voice x\hat{ } generated by the decoder G.

Next, learning processing performed in the learning system 200 will be described.

The I2A is a converter that converts the face image y of the speaker into the avatar image a of the speaker (described above) and can perform learning by using an approach based on, for example, a generative adveralial network (see, for example, Non-Patent Document 1).

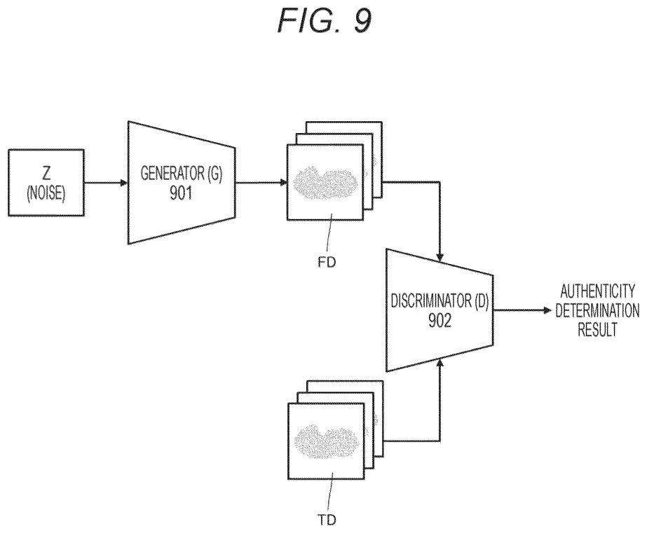

Here, a GAN algorithm will be briefly described with reference to FIG. 9. The GAN uses a generator (G) 901 and a discriminator (D) 902. The generator 901 and the discriminator 902 are each configured by a neural network model. The generator 901 adds noise (random latent variable z) to an input image and generates a false image FD. Meanwhile, the discriminator 902 discriminates authenticity of a true image TD from the image FD generated by the generator 901. Then, the generator 901 performs learning while competing with the discriminator 902 such that the generator 901 makes it more difficult for the discriminator 902 to discriminate the authenticity, whereas the discriminator 902 can correctly discriminate the authenticity of the image generated by the generator 901, whereby the generator 901 can generate an image whose authenticity cannot be determined. The converter I2A learned by using the GAN algorithm or the like can generate the avatar image a of the speaker whose authenticity cannot be determined from the face image y of the speaker.

Returning to FIG. 2 again, description of the learning system 200 will be continued. A voice xⁱ, a face image yⁱ, and an avatar image aⁱ are prepared as learning data from each of utterance videos of a plurality of speakers. Here, i represents an index of the speaker. Further, the avatar image aⁱ is generated from the face image yⁱ as in aⁱ=I(yⁱ) by using the converter I2A.

Next, the encoders E_{speech}, Eₚₕₒₜₒ, and Eₐᵥₐₜₐᵣ extract speaker feature values dⁱ_{speech}, dⁱₚₕₒₜₒ, and dⁱₐᵥₐₜₐᵣ from domains of the voice xⁱ, the face image yⁱ, and the avatar image aⁱ, respectively, as shown in the following equations (1) to (3).

$$\begin{matrix}[ Math . 1 ] & \\ {E}_{speech} ( {x}^{i} ) = {d}_{speech}^{i} & ( 1 )\end{matrix}$$

$$\begin{matrix}[ Math . 2 ] & \\ {E}_{photo} ( {y}^{i} ) = {d}_{photo}^{i} & ( 2 )\end{matrix}$$

$$\begin{matrix}[ Math . 3 ] & \\ {E}_{avatar} ( {a}^{i} ) = {d}_{avatαr}^{i} & ( 3 )\end{matrix}$$

Each of the encoders E_{speech}, Eₚₕₒₜₒ, and Eₐᵥₐₜₐᵣ can be configured by a DNN model. The speaker feature value is expressed as a time-invariant feature value. The speaker feature values dⁱ_{speech}, dⁱₚₕₒₜₒ, and dⁱₐᵥₐₜₐᵣ extracted from the voice xⁱ, the face image yⁱ, and the avatar image aⁱ of the same speaker i by the respective encoders EₑₑEₚₕₒₜₒ, and Eₐᵥₐₜₐᵣ desirably share the same space (speaker feature value space) and are desirably the same. Therefore, a loss function L_{enc} used for learning the encoders E_{speech}, Eₚₕₒₜₒ, and Eₐᵥₐₜₐᵣ is defined as shown in the following equation (4). Note that, in the following equation (4), α₁, α₂, and α₃ are positive constants and are weighting coefficients for a difference between the speaker feature values of the domains of the same speaker i.

$$\begin{matrix}[ Math . 4 ] & \\ {L}_{enc} = {α}_{1} ‖ {d}_{speech}^{i} - {d}_{avatar}^{i} ‖ + {α}_{2} ‖ {d}_{avatar}^{i} - {d}_{photo}^{i} ‖ + {α}_{3} ‖ {d}_{photo}^{i} - {d}_{speech}^{i} ‖ & ( 4 )\end{matrix}$$

Further, the encoder E_{content} acquires a feature value cⁱ depending on utterance content but not depending on the speaker from the voice xⁱ of the speaker i as shown in the following equation (5).

$$\begin{matrix}[ Math . 5 ] & \\ {c}^{i} = {E}_{content} ( {x}^{i} ) & ( 5 )\end{matrix}$$

The decoder G can be designed and learned as an autoregressive model or a generation model such as a GAN. Here, a case of using adversarial learning, that is, a GAN algorithm will be described. The GAN algorithm is as described above with reference to FIG. 9. The random latent variable z is further added as an input of the decoder G to obtain the output x\hat{ }. A loss function L_{adv} for adversarial learning shown in the following equation (6) is defined by using the discriminator D that determines whether the voice x\hat{ } generated by the decoder G is an authentic voice or a voice generated by the decoder G.

$$\begin{matrix}[ Math . 6 ] & \\ {L}_{adv} = {𝔼}_{x} log ( D ( {x}^{ì} ) ) + log ( 1 - D ( G ( {c}^{i} , {d}_{*}^{i} ) ) ) & ( 6 )\end{matrix}$$

By minimizing the loss function L_{adv} for the decoder G and the encoders E_{speech}, Eₚₕₒₜₒ, and Eₐᵥₐₜₐᵣ and maximizing the loss function L_{adv} for the discriminator D, the decoder G can output a natural voice x\hat{ }. That is, the decoder G performs learning while competing with the discriminator D such that the decoder G makes it more difficult for the discriminator D to discriminate the authenticity, whereas the discriminator D can correctly discriminate the authenticity of the voice x\hat{ } output from the decoder G, whereby the decoder G can generate a voice whose authenticity cannot be or rarely determined by the discriminator D.

Further, the learning system 200 introduces a speaker discriminator C such that the output voice x\hat{ } of the decoder G has a voice quality of the speaker i set by the speaker feature value d*. The speaker discriminator C is learned such that the decoder G correctly estimates an original speaker from an output generated by using a speaker feature value d^{j}* extracted from a speaker different from the original speaker i. In the present embodiment, a loss function L_{cls} shown in the following equation (7) is defined to learn the speaker discriminator C by using cross-entropy CE(x, i).

$$\begin{matrix}[ Math . 7 ] & \\ {L}_{cls} = {𝔼}_{{x}^{i} {x}^{j} , i \neq j} CE ( G ( {c}^{i} , {d}_{⋆}^{j} ) , i ) & ( 7 )\end{matrix}$$

Meanwhile, the decoder G and the encoders E_{speech}, Eₚₕₒₜₒ, and Eₐᵥₐₜₐᵣ are learned by adversarial learning such that it is difficult for the speaker discriminator C to identify the speaker (that is, the speaker discriminator C is deceived). For this purpose, a loss function L_{advcls} shown in the following equation (8) is defined. The speaker discriminator C is fixed, and the decoder G and the encoders E_{speech}, Eₚₕₒₜₒ, and Eₐᵥₐₜₐᵣ are learned to minimize the following equation (8).

$$\begin{matrix}[ Math . 8 ] & \\ {L}_{advcls} = {𝔼}_{{x}^{i} {x}^{j} , i \neq j} CE ( G ( {c}^{i} , {d}_{*}^{j} ) , j ) & ( 8 )\end{matrix}$$

Further, the loss function L_{rec} shown in the following equation (9) is defined to perform regularization such that an output G(cⁱ, d*^{j}) of the decoder G has the same utterance content as an input x.

$$\begin{matrix}[ Math . 9 ] & \\ {L}_{rec} = {𝔼}_{x} ‖ f ( G ( {c}^{i} , {d}_{*}^{j} ) ) - f ( x ) ) ‖ & ( 9 )\end{matrix}$$

Note that f( ) in the above equation (9) is a function that extracts high-level semantic information such as voice recognition and downsampling. Further, a term for performing regularization such that input and output of pitch variation and volume variation match may be added to the above equation (9).

To summarize the above (the above equations (4) and (6) to (9)), an objective function of learning the encoders E_{speech}, Eₚₕₒₜₒ, and Eₐᵥₐₜₐᵣ and the decoder G and an objective function of learning the discriminator D and the speaker discriminator C can be shown as in the following equation (10). Note that, in the following equation (10), λ_{enc}, λ_{adv}, λ_{advcls}, and λ_{rec} are positive constants and are weighting coefficients for the loss functions L_{enc}, L_{adv}, L_{advcls}, and L_{rec} individually shown in the above equations (4) and (6) to (9). With the above loss functions, DNN models each configuring the encoders E_{speech}, Eₚₕₒₜₒ, and Eₐᵥₐₜₐᵣ, the decoder G, the discriminator D, and the speaker discriminator C are learned.

$$\begin{matrix}[ Math . 10 ] & \\ {min}_{E , G} {λ}_{enc} {L}_{enc} + {λ}_{adv} {L}_{adv} + {λ}_{advcls} {L}_{advcls} + {λ}_{rec} {L}_{rec} & ( 10 )\end{matrix}$$

### B-2-2: At the Time of Inference

Next, an inference operation by the voice quality conversion device 100 using each DNN model learned by the method described in the above section B-2-1 will be described. At the time of inference, by using the learned avatar encoder Eₐᵥₐₜₐᵣ as the avatar speaker feature value extractor 101 and using the decoder G as the voice quality converter 104 in the voice quality conversion device 100, a voice uttered by a speaker is converted into a voice quality matching an impression of an avatar image of the speaker.

With the loss function L_{enc} in the above equation (4), a speaker feature value space extracted by the avatar encoder Eₐᵥₐₜₐᵣ from the avatar image, a speaker feature value space extracted by the encoder E_{speech} from the voice of the speaker, and a speaker feature value space extracted by the encoder Eₚₕₒₜₒ from a face image of the speaker are designed to be common. Further, when a model is learned by using a sufficiently large number of speakers, the model is expected to be generalized to a new speaker. That is, even for a new avatar image a that is unknown at the time of learning, the speaker feature value dₐᵥₐₜₐᵣ extracted by the avatar encoder Eₐᵥₐₜₐᵣ from the avatar image is expected to be the same as a speaker feature value extracted by the encoder E_{speech} from a voice of an original speaker of the avatar image and be the same as a speaker feature value extracted by the encoder Eₚₕₒₜₒ from a face image of the original speaker.

Therefore, according to the design method described in the section B-2, even if a new avatar image for which an original speaker does not actually exist (in other words, an unknown avatar image that is not included when the voice quality conversion device 100 is designed or when a model is learned) is input, the voice quality conversion device 100 can extract a speaker feature value matching an impression of the avatar image only from the avatar image and convert a voice of the speaker into a voice of a natural voice quality matching the impression of the avatar image.

Note that, in the above description, the learning method using the face image yⁱ of the speaker i and the encoder Eₚₕₒₜₒ that extracts a speaker feature value dₚₕₒₜₒⁱ from the face image has been described. However, in a case where it is unnecessary to extract a speaker feature value from a face image at the time of inference as described later, the encoder Eₚₕₒₜₒ is not necessarily required, and the learning may be performed without using the encoder Eₚₕₒₜₒ. Further, when each model is learned in the learning system 200 of FIG. 2, a data set is not necessarily a set of three of a voice, a face image, and an avatar image, and the learning can also be performed by using, for example, two paired data such as (voice and face image) and (face image and avatar image).

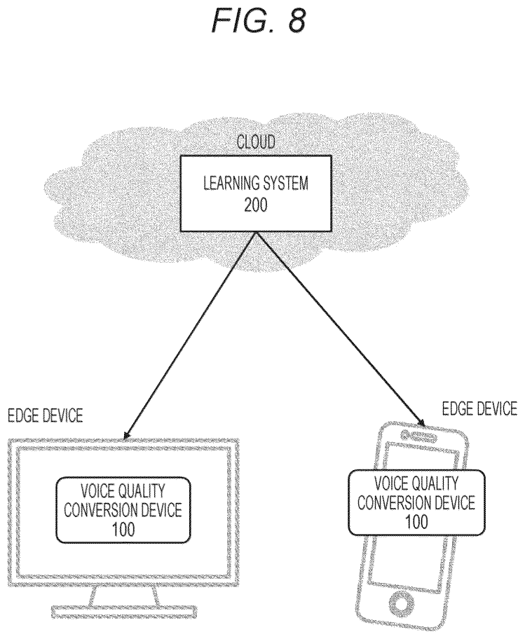

A huge amount of data sets and calculation resources are required for deep learning (DL) of models used for an avatar encoder and a voice quality converter. Therefore, each model may be learned on a cloud, then acquired information of the model may be downloaded to an edge device such as a personal computer (PC), a smartphone, or a tablet, and inference may be performed in the edge device that creates and uses an avatar. In this case, as shown in FIG. 8, a cooperative operation is implemented such that the learning system 200 is implemented on the cloud, whereas the voice quality conversion device 100 is implemented in the edge device, and parameters of the models for the avatar encoder Eₐᵥₐₜₐᵣ and the decoder G learned in the learning system 200 are set in the voice quality conversion device 100 of the edge device. As a matter of course, both the voice quality conversion device 100 and the learning system 200 can be implemented together in one of the cloud and the edge device.

### B-3. Method (2) of Designing Speaker Feature Value Extractor and Voice Quality Converter

In the above section B-2, there has been described the method of designing each DNN model used as the speaker feature value extractor and the voice quality converter in the voice quality conversion device 100 such that a speaker feature value extracted from a voice uttered by a speaker or a face image of the speaker and a speaker feature value extracted from an avatar image generated from the face image of the speaker share the same space (speaker feature value space) and are close feature values on the space. Meanwhile, in this section B-3, there will be described a method of describing a voice uttered by a speaker, a face image of the speaker, and an avatar image by using a common impression word and designing a DNN model by using the impression word as a speaker feature value. In the design method described in the section B-3, paired data of a voice, a face image, and an avatar image is not required.

First, a set of impression words W=[w₁, . . . , w_{N}] is defined, and a determiner M for determining whether or not the impression words correspond to each image or voice is prepared. Examples of the impression words include “mild”, “cold”, “crisp”, and “aged”. The impression words are expressed by a predetermined class and have an advantage that humans can understand the impression words more easily than the speaker feature value.

Specifically, a determiner M_{speech} that determines whether or not each impression word corresponds to a voice x, a determiner Mₚₕₒₜₒ that determines whether or not each impression word corresponds to an image y, and a determiner Mₐᵥₐₜₐᵣ that determines whether or not each impression word corresponds to an avatar image a are prepared. Each of the determiners M_{speech}, Mₚₕₒₜₒ, and Mₐᵥₐₜₐᵣ is configured by a DNN model, but the avatar image, voice, and face image necessary for learning those models do not need to be generated from the same speaker. Further, the learning of the models of those determiners needs to be performed independently of learning of the decoder G. When determination results of the determiners M_{speech}, Mₚₕₒₜₒ, and Mₐᵥₐₜₐᵣ are represented as W\hat{ }_{speech}, W\hat{ }ₚₕₒₜₒ, and W\hat{ }ₐᵥₐₜₐᵣ, respectively, the determination results are shown as in the following equations (11) to (13).

$$\begin{matrix}[ Math . 11 ] & \\ {\hat{W}}_{speech} = {M}_{speech} ( x ) & ( 11 )\end{matrix}$$

$$\begin{matrix}[ Math . 12 ] & \\ {\hat{W}}_{photo} = {M}_{photo} ( y ) & ( 12 )\end{matrix}$$

$$\begin{matrix}[ Math . 13 ] & \\ {\hat{W}}_{avatar} = {M}_{avatar} ( a ) & ( 13 )\end{matrix}$$

Note that an impression word W\hat{ } determined from a voice or an image by each determiner M_{speech}, Mₚₕₒₜₒ, or Mₐᵥₐₜₐᵣ is a posterior probability corresponding to each impression word (the impression word W\hat{ } belongs to R^{N}). Each of the determiners M_{speech}, Mₚₕₒₜₒ, and Mₐᵥₐₜₐᵣ can perform learning by using data for each input domain (x, y, a).

A speaker feature value d can be shown in the following equation (14) by using an impression feature value matrix P=[e₁, . . . , e_{N}]^{T} having a feature value vector eᵢ corresponding to each impression word wᵢ as an element.

$$\begin{matrix}[ Math . 14 ] & \\ {d}_{*} = P {\hat{W}}_{*} & ( 14 )\end{matrix}$$

The above equation (14) shows that an impression word can be projectively transformed into a speaker feature value by using the impression feature value matrix P. That is, by using the above equation (14), it is possible to projectively transform the impression word determination results W\hat{ }_{speech}, W\hat{ }ₚₕₒₜₒ, and W\hat{ }Photo determined from a voice or an image by each determiner into the speaker feature values d_{speech}, dₚₕₒₜₒ, and dₐᵥₐₜₐᵣ, respectively.

Hereinafter, each DNN model can be learned by a method similar to that described in the above section B-2-1.

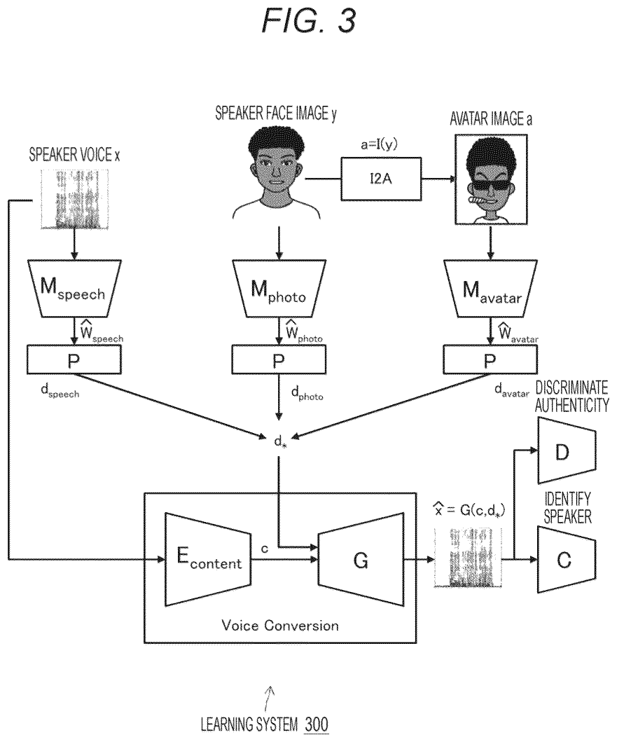

FIG. 3 shows a functional configuration of a learning system 300 that describes a voice uttered by a speaker, a face image of the speaker, and an avatar image by using a common an impression word and learns each DNN model in the voice quality conversion device 100 by using the impression word as the speaker feature value. A main difference from the learning system 200 of FIG. 2 is that the determiners M_{speech}, Mₚₕₒₜₒ, and Mₐᵥₐₜₐᵣ are arranged instead of the encoders E_{speech}, Eₚₕₒₜₒ, and Eₐᵥₐₜₐᵣ that extract speaker feature values from a voice, a face image, and an avatar image.

As described above, a set of impression words W=[w₁, . . . , w_{N}] is defined, and each of the determiners M_{speech}, Mₚₕₒₜₒ, and Mₐᵥₐₜₐᵣ determines whether or not each of the impression words [w₁, . . . , w_{N}] corresponds to a voice of a speaker, a face image of the speaker, or an avatar image generated from the voice or face image of the speaker and outputs an impression feature value as shown in the above equations (11) to (13). Further, the impression word determination results W\hat{ }_{speech}, W\hat{ }Photo, and W\hat{ }ₚₕₒₜₒ output from the determiners M_{speech}, Mₚₕₒₜₒ, and Mₐᵥₐₜₐᵣ are projectively transformed into the speaker feature values d_{speech}, dₚₕₒₜₒ, and dₐᵥₐₜₐᵣ, respectively, by using the impression feature value matrix P by using the above equation (14).

The loss function Lₑₙₑ in the above equation (4) is defined because the speaker feature values dⁱ_{speech}, dⁱₚₕₒₜₒ, and dⁱₐᵥₐₜₐᵣ obtained from the voice xⁱ, the face image yⁱ, and the avatar image aⁱ of the same speaker i through impression word expression and projective transformation are desirably the same. Further, the loss function L_{adv} in the above equation (6) is defined for the decoder G to perform learning so as to deceive the discriminator D by adversarial learning. Furthermore, the loss function L_{cls} in the above equation (7) is defined for learning the speaker discriminator C, and the loss function L_{cls} in the above equation (8) is defined for the decoder G and the determiners M_{speech}, Mₚₕₒₜₒ, and Mₐᵥₐₜₐᵣ to perform learning so as to deceive the speaker discriminator C by adversarial learning. Furthermore, the loss function L_{rec} in the above equation (9) is defined for performing regularization such that the output G(cⁱ, d*^{j}) of the decoder G has the same utterance content as the input x. In this way, it is possible to obtain the objective function of learning the determiners M_{speech}, Mₚₕₒₜₒ, and Mₐᵥₐₜₐᵣ and the decoder G in the above equation (10) and learn each DNN model.

Subsequently, at the time of inference, the learned determiner Mₐᵥₐₜₐᵣ is used as the avatar speaker feature value extractor 101, and the decoder G is used as the voice quality converter 104. The avatar speaker feature value extractor 101 determines whether or not each impression word included in the impression word set W corresponds to an avatar image of the speaker i and projectively transforms the determination result W\hat{ }ₐᵥₐₜₐᵣ into the speaker feature value dⁱₐᵥₐₜₐᵣ by using the impression feature value matrix P. The avatar image may be an unknown avatar image when a model is designed. Then, the voice quality converter 104 converts a voice uttered by the speaker i into an avatar voice having a voice quality matching an impression of the avatar image aⁱ on the basis of the speaker feature value dⁱₐᵥₐₜₐᵣ obtained from the avatar image of the speaker i.

Therefore, also according to the design method described in the section B-3, even if a new avatar image for which an original speaker does not actually exist (in other words, an unknown avatar image that is not included when the voice quality conversion device 100 is designed or when a model is learned) is input, the voice quality conversion device 100 can extract a speaker feature value matching an impression of the avatar image only from the avatar image and convert a voice of the speaker into a voice of a natural voice quality matching the impression of the avatar image.

Also in this design method, the models used for the avatar encoder and the voice quality converter may be learned on a cloud, then acquired information of the models may be downloaded to an edge device such as a PC, a smartphone, or a tablet, and inference may be performed in the edge device that creates and uses an avatar. Also in this case, as in FIG. 8, a cooperative operation is implemented such that the learning system 300 is implemented on the cloud, whereas the voice quality conversion device 100 is implemented in the edge device, and parameters of the models for the avatar determiner Mₐᵥₐₜₐᵣ and the decoder G learned in the learning system 300 are set in the voice quality conversion device 100 of the edge device. As a matter of course, both the voice quality conversion device 100 and the learning system 300 can be implemented together in one of the cloud and the edge device.

### B-4. Mixing of Original Speaker Feature Value

In a situation where types of avatars are limited by a service, voice qualities corresponding to the avatars are also limited. In such a situation, frequently, there is a need to have a certain degree of individuality without having the same voice quality as an avatar of another person. Therefore, in this section B-4, there will be described a method of mixing a speaker feature value extracted from a voice or face image of an original speaker with a speaker feature value extracted from an avatar image and adding individuality (i.e. an impression of a voice quality of the original speaker) to a voice quality of a voice of the avatar image.

As described in the above section B-2-1, speaker feature value spaces extracted by the encoders E_{speech}, Eₚₕₒₜₒ, and Eₐᵥₐₜₐᵣ from a voice, a face image, and an avatar image are designed to be common. Therefore, speaker feature values extracted from different domains can be interpolated and extrapolated. Therefore, as shown in the following equation (15), the voice quality conversion processing of a voice of an original speaker is performed by using the speaker feature value d obtained by synthesizing the speaker feature value d_{speech} extracted from the voice of the speaker with the speaker feature value dₐᵥₐₜₐᵣ extracted from the avatar image. Alternatively, as shown in the following equation (16), the voice quality conversion processing of the voice of the original speaker is performed by using the speaker feature value d obtained by synthesizing the speaker feature value dₚₕₒₜₒ extracted from the face image of the speaker with the speaker feature value dₐᵥₐₜₐᵣ extracted from the avatar image.

$$\begin{matrix}[ Math . 15 ] & \\ d = ( 1 - y ) {d}_{avatar} + γ {d}_{speech} & ( 15 )\end{matrix}$$

$$\begin{matrix}[ Math . 16 ] & \\ d = ( 1 - γ ) {d}_{avatar} + γ {d}_{photo} & ( 16 )\end{matrix}$$

In the above equations (15) and (16), γ represents a small constant satisfying |γ|<1. When γ is a positive value, it means that the speaker feature value dₚₕₒₜₒ is interpolated into the speaker feature value dₐᵥₐₜₐᵣ, and, when γ is a positive value, it means that the speaker feature value dₚₕₒₜₒ is extrapolated to the speaker feature value dₐᵥₐₜₐᵣ. By setting a larger value to γ and increasing a ratio of the speaker feature value d_{speech} or dₚₕₒₜₒ extracted from the original speaker, the voice quality estimated from the avatar image can be changed to be closer to the original speaker. Conversely, by setting a smaller value to γ and decreasing the ratio of the speaker feature value d_{speech} or dₚₕₒₜₒ extracted from the original speaker, the voice quality estimated from the avatar image can be changed to be farther from the original speaker.

As described in the above section B-1 with reference to FIG. 1, the voice quality conversion device 100 optionally includes the speaker feature value extractor 102 and the feature value synthesis unit 103. The speaker feature value extractor 102 extracts a speaker feature value from at least one of the face image of the speaker or the voice of the speaker. Then, the feature value synthesis unit 103 mixes the speaker feature value extracted by the speaker feature value extraction unit 102 with the speaker feature value extracted from the avatar image according to the above equation (15) or (16). In this way, the voice quality converter 104 can convert the voice quality of the voice uttered by the speaker on the basis of the synthesized speaker feature value. The mixing ratio γ may be a fixed value given in advance to the voice quality conversion device 100 (or the feature value synthesis unit 103) or may be changed from a default value in response to an instruction from the user via the UI or the like.

### C. Voice Synthesis

In this section C, voice synthesis processing of setting a voice quality when synthesizing a voice of an avatar from text so as to match an impression of an avatar image according to the present disclosure will be described.

### C-1. Configuration of Voice Synthesis Device

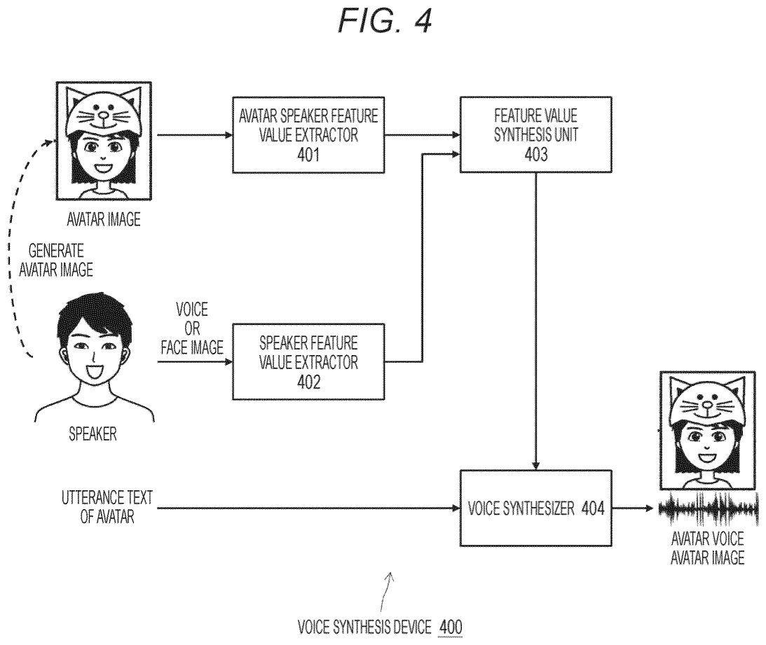

FIG. 4 schematically shows a functional configuration of a voice synthesis device 400 that sets a voice quality when synthesizing a voice of an avatar from text so as to match an impression of an avatar image by applying the present disclosure. The voice synthesis device 400 in FIG. 4 includes an avatar speaker feature value extractor 401 and a voice synthesizer 404 as basic components. The avatar speaker feature value extractor 401 extracts a speaker feature value from an input avatar image. Then, when text to be uttered by an avatar is input, the voice synthesizer 404 sets a voice quality when synthesizing a voice of the avatar from the text so as to match an impression of the avatar image on the basis of the speaker feature value extracted by the avatar speaker feature value extractor 401 from the avatar image.

Further, the voice synthesis device 400 in FIG. 4 may further optionally include a speaker feature value extractor 402 and a feature value synthesis unit 403. The speaker feature value extractor 402 extracts a speaker feature value from at least one of a face image of a speaker or a voice of the speaker. The feature value synthesis unit 403 mixes the speaker feature value extracted by the speaker feature value extractor 402 from the face image or voice of the speaker with the speaker feature value extracted by the avatar speaker feature value extractor 401 from the avatar image. The speaker feature values extracted from the speaker feature value extractors 401 and 402 share the same space (same as above), and thus synthesis processing can be performed in the feature value synthesis unit 403. Then, the voice synthesizer 404 sets the voice quality when synthesizing the voice of the avatar from the text on the basis of the synthesized speaker feature value. In the feature value synthesis unit 403, when the mixing ratio of the speaker feature value extracted by the speaker feature value extractor 402 is increased, the voice of the avatar image can be closer to the voice quality of the original speaker.

Among the components of the voice synthesis device 400 in FIG. 4, the avatar speaker feature value extractor 401, the speaker feature value extractor 402, and the voice synthesizer 404 are implemented through statistical learning processing by using respective DNN models.

### C-2. Method of Designing Speaker Feature Value Extractor and Voice Synthesizer

By a method similar to the method described in the above section B-2 or the above section B-3, it is possible to design DNN models used for the speaker feature value extractor 401 and the voice synthesizer 404 of the voice synthesis device 400 in FIG. 4.

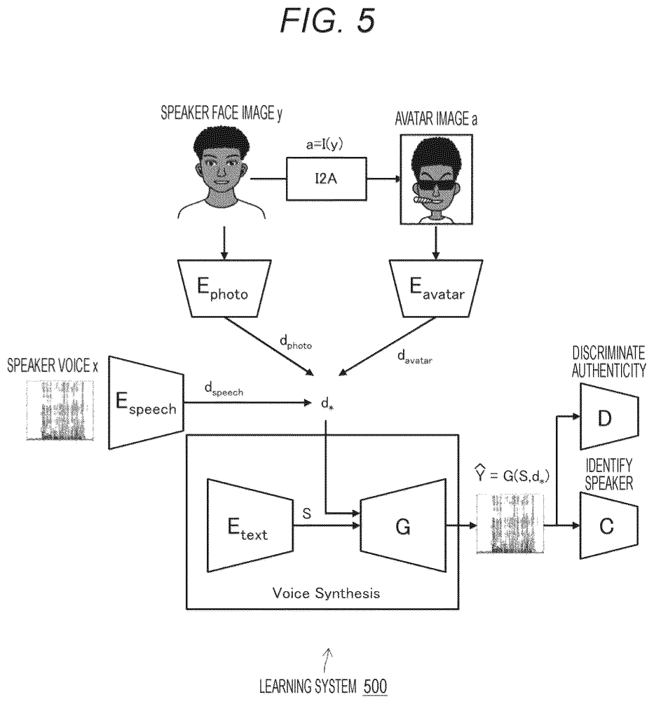

FIG. 5 shows a functional configuration of a learning system 500 that learns each DNN model in the voice synthesis device 400 by using speaker feature values that are extracted from a voice uttered by a speaker, a face image of the speaker, and an avatar image and share the same space. The learning system 500 and a learning method will be described, focusing on differences from the learning system 200 of FIG. 2.

The encoders E_{speech}, Eₚₕₒₜₒ, and Eₐᵥₐₜₐᵣ extract the speaker feature values d_{speech}, dₚₕₒₜₒ, and dₐᵥₐₜₐᵣ from a voice of a speaker, a face image of the speaker, and an avatar image generated from the face image of the speaker. Further, a text encoder Eₜₑₓₜ extracts text embedding S=[s₁, . . . , s_{N}] from utterance text of learning voice data. Then, the voice synthesizer G inputs the speaker feature value d* extracted from one of the encoders E_{speech}, Eₚₕₒₜₒ, and Eₐᵥₐₜₐᵣ and the text embedding S as shown in the following equation (17) and estimates the corresponding voice feature value sequence Y=[y₁, . . . , y_{N}].

$$\begin{matrix}[ Math . 17 ] & \\ \hat{Y} = G ( S , {d}_{*} ) & ( 17 )\end{matrix}$$

Each of the encoders E_{speech}, Eₚₕₒₜₒ, and Eₐᵥₐₜₐᵣ can be configured by a DNN model, and speaker feature values extracted by the respective encoders desirably share the same space (speaker feature value space) and are desirably the same. Therefore, the loss function L_{enc} in the above equation (4) is defined to learn the encoders E_{speech}, Eₚₕₒₜₒ, and Eₐᵥₐₜₐᵣ (same as above).

The voice synthesizer G can be configured by a DNN model. The voice synthesizer G can be learned by using, for example, a squared error function so as to minimize an error between an estimated value Y\hat{ } and a correct voice feature value sequence Y. In a case where the encoders E_{speech}, Eₚₕₒₜₒ, and Eₐᵥₐₜₐᵣ and the voice synthesizer G are learned by a statistical method in a similar manner to the description in the above section B-2, a loss function L shown in the following equation (18) is defined. That is, the encoders E_{speech}, Eₚₕₒₜₒ, and Eₐᵥₐₜₐᵣ and the voice synthesizer G are learned to minimize the loss function L.

$$\begin{matrix}[ Math . 18 ] & \\ L = {‖ Y - G ( S , {d}_{*} ) ‖}_{2}^{2} + λ {L}_{enc} & ( 18 )\end{matrix}$$

Next, an inference operation by the voice synthesis device 400 using each DNN model learned by the above method will be described. At the time of inference, in the voice synthesis device 400, the learned avatar encoder Eₐᵥₐₜₐᵣ is used as the avatar speaker feature value extractor 401, and the voice synthesizer G is used as the voice synthesizer 404. Then, the voice synthesizer G receives input of a speaker feature value extracted from an avatar image and thus performs voice synthesis of utterance text S with a voice quality matching an impression of the avatar image.

According to the design method described in the section C-2, even if a new avatar image for which an original speaker does not actually exist (in other words, an unknown avatar image that is not included when the voice synthesis device 400 is designed or when a model is learned) is input, the voice synthesis device 400 can extract a speaker feature value matching an impression of the avatar image only from the avatar image and perform voice synthesis of arbitrary utterance text with a natural voice quality matching the impression of the avatar image.

Note that, in a case where it is unnecessary to extract a speaker feature value from a face image at the time of inference, the encoder Eₚₕₒₜₒ is not necessarily required, and learning may be performed without using the encoder Eₚₕₒₜₒ. Further, when each model is learned in the learning system 500 of FIG. 5, a data set is not necessarily a set of three of a voice, a face image, and an avatar image, and the learning can also be performed by using, for example, two paired data such as (voice and face image) and (face image and avatar image).

Further, as in the design method described in the above section B-3, it is also possible to describe a voice uttered by a speaker, a face image of the speaker, and an avatar image by using a common impression word and design a DNN model by using the impression word as a speaker feature value.

Further, individuality can be given to a synthesized voice by performing voice synthesis of utterance text on the basis of a speaker feature value obtained by synthesizing a speaker feature value extracted from a voice of a speaker and a speaker feature value extracted from an avatar image according to the above equation (15) or synthesizing a speaker feature value extracted from a face image of the speaker and the speaker feature value extracted from the avatar image according to the above equation (16) as in the design method described in the above section B-4.

Also in voice synthesis, as in the case of voice quality conversion in the above section B, the models used for the avatar encoder and the voice synthesizer may be learned on a cloud, then acquired information of the models may be downloaded to an edge device such as a PC, a smartphone, or a tablet, and inference may be performed in the edge device that creates and uses an avatar. Also in this case, as in FIG. 8, a cooperative operation is implemented such that the learning system 500 is implemented on the cloud, whereas the voice synthesis device 400 is implemented in the edge device, and parameters of the models for the avatar encoder Eₐᵥₐₜₐᵣ and the decoder G learned in the learning system 500 are set in the voice synthesis device 400 of the edge device. As a matter of course, both the voice synthesis device 400 and the learning system 500 can be implemented together in one of the cloud and the edge device.

### D. Tools

In this section D, an example of a user interface (UI) when the voice quality conversion processing matching an impression of an avatar image according to the present disclosure is implemented will be described. In a case where an avatar is created and used in the edge device, for example, models of the avatar encoder and the voice quality converter are learned on the cloud, then information of the models is downloaded to the edge device, and the voice quality conversion device 100 in which parameters of the learned models are set operates in the edge device. Further, the UI described below is utilized in the edge device.

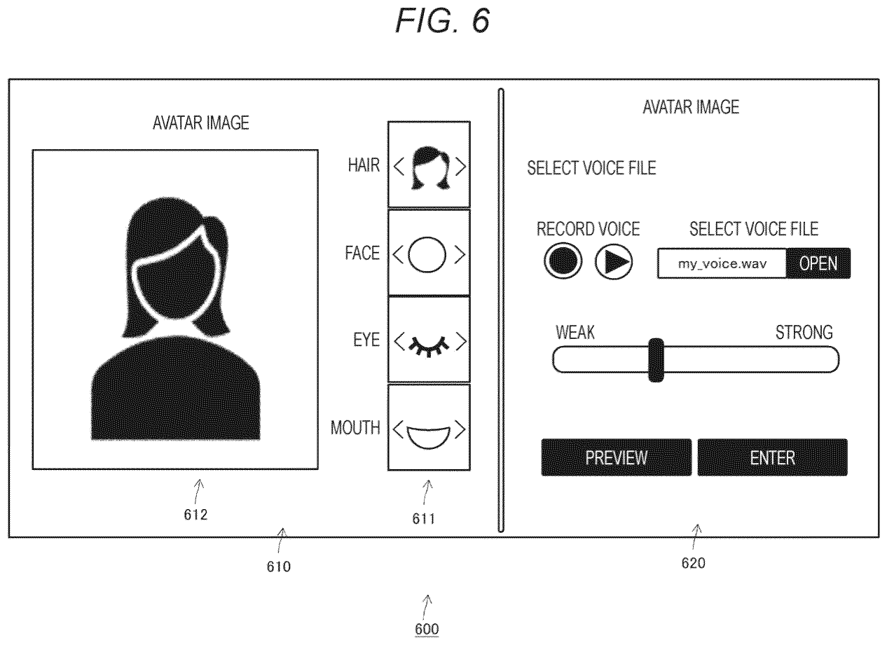

FIG. 6 shows a configuration example of a UI screen for adjusting the voice quality conversion processing of a voice of an avatar. A UI screen 600 in FIG. 6 has an avatar image editing region 610 in its left half and a voice setting region 620 for setting a voice of an avatar in its right half.

In the avatar image editing region 610, an avatar image corresponding to an original speaker is edited. The avatar image editing region 610 has a selection region 611 for selecting each face part such as hair, a face (contour of the face), eyes, and a mouth and an avatar image display region 612 for displaying an avatar image created by combining each selected face part. In the selection region 611, each face part can be sequentially switched by clicking or touching left and right cursors.

An avatar image a created in the avatar image editing region 610 is input to the avatar speaker feature value extractor 101 of the voice quality conversion device 100, and the speaker feature value dₐᵥₐₜₐᵣ is extracted by the avatar encoder Eₐᵥₐₜₐᵣ including a learned model.

In the voice setting region 620, an input operation for setting a voice quality of a voice of an avatar is performed. First, in the voice setting region 620, an operation of selecting a voice file of an original speaker to be used for individualizing a voice of an avatar image is performed. The voice file for individualizing a voice quality can be acquired by using a voice recording function of the edge device. The speaker can record utterance by pressing a record button in the voice setting region 620. Further, a voice file already recorded in a local memory in the edge device can be selected for individualizing the voice quality. Then, when a reproduction button is pressed, the selected voice file can be reproduced to confirm the voice to be used for individualizing the voice quality. A voice x specified by recording or selecting a file in this manner is input to the speaker feature value extractor 102 of the voice quality conversion device 100, and the speaker feature value d_{speech} is extracted by the encoder E_{speech} including a learned model.

Subsequently, in the voice setting region 620, an intensity of individualizing the voice quality of the voice of the avatar image to the voice quality of the speaker can be specified by adjusting a slider bar according to the user's preference. When a knob that is an input element is slid in a direction of “strong” on the slider bar, the voice quality estimated from the avatar image can be changed to be closer to the original speaker. Conversely, when the knob is slid in a direction of “weak” on the slider bar, the voice quality estimated from the avatar image can be changed to be farther from the original speaker. The adjustment using the slider bar corresponds to the adjustment of the value γ representing the mixing ratio of the original speaker feature value described in the above section B-4.

Then, the voice quality conversion device 100 operating in the edge device synthesizes the speaker feature value dₐᵥₐₜₐᵣ and the speaker feature value d_{speech} of the voice of the original speaker, both of which are acquired through the above UI operation, by using γ specified on the slider bar in the voice setting region 620 according to the above equation (15), thereby obtaining the speaker feature value d. The voice quality converter 104 is the decoder G including a learned model and converts a voice c uttered by the speaker into a voice of a voice quality G(c, d) matching an impression of the avatar image a created in the avatar image editing region 610 on the basis of the synthesized speaker feature value d. The user can press a “preview” button to listen to a reproduced voice of the avatar after the voice quality conversion and check whether or not the voice matches the impression of the edited avatar image. Then, in a case where the user is satisfied with the avatar image edited on the UI screen 600 and the voice of the avatar adjusted thereon, the user presses an “enter” button to settle the avatar image and the voice.

According to the UI configuration of FIG. 6, it is possible to edit the avatar image and finely set the voice quality of the voice uttered by the avatar image, but the UI operation is complicated. For example, in a case of a PC including a full-size keyboard and a mouse, it is possible to easily perform a fine input operation for adjusting the above voice quality conversion on the UI screen of FIG. 6, but the input operation is a complicated UI operation on a touchscreen such as a smartphone or a tablet.

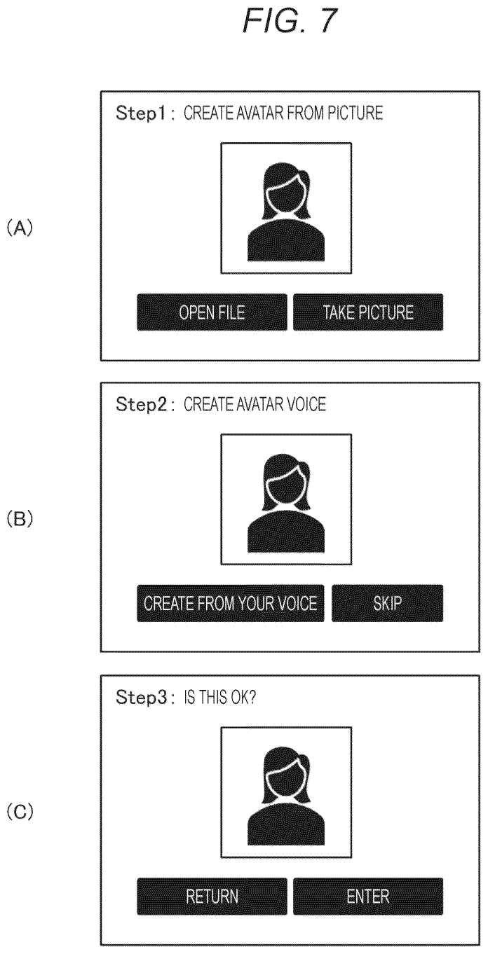

Therefore, FIG. 7 shows another configuration example of the UI screen in which the operation of adjusting the voice quality conversion processing of a voice of an avatar is simplified. In the example of FIG. 7, an operation for adjusting the voice quality conversion processing of a voice of an avatar is sequentially performed by using screen transition.

First, as shown in FIG. 7(A), as a first step, an avatar image of a speaker is generated from a face image of the speaker. On the UI screen of FIG. 7(A), a face image file of the speaker already imaged and stored can be selected by pressing an “open file” button, or a face image file can be acquired on the spot by pressing a “take picture” button to image the face of the speaker by using a camera function of the edge device. Then, in the edge device, the function of the converter I2A that converts the face image y of the speaker into an avatar image operates in the background to generate the avatar image a. Unlike the UI screen of FIG. 6, the avatar image cannot be edited in detail, but the avatar image a can be acquired only by a simple UI operation of specifying the original face image file.

The avatar image a acquired through the UI screen of FIG. 7(A) is input to the avatar speaker feature value extractor 101 of the voice quality conversion device 100, and the speaker feature value dₐᵥₐₜₐᵣ is extracted by the avatar encoder Eₐᵥₐₜₐᵣ including a learned model.

Next, as shown in FIG. 7(B), as a second step, when a “create from your voice” button is pressed, a voice of the original speaker is recorded, and a voice quality of the generated avatar is adjusted. Alternatively, recording of the voice of the original speaker is skipped by pressing a “skip” button.

The voice x recorded through the UI screen of FIG. 7(B) is input to the speaker feature value extractor 102 of the voice quality conversion device 100, and the speaker feature value d_{speech} is extracted by the encoder E_{speech} including a learned model. In order to solve the complication, the UI operation for adjusting the intensity of individualizing the voice quality of the voice of the avatar image to the voice quality of the speaker is omitted on the UI screen of FIG. 7, and the acquired speaker feature value dₐᵥₐₜₐᵣ and the acquired speaker feature value d_{speech} of the voice of the original speaker are synthesized by using a preset value for γ according to the above equation (15), thereby obtaining the speaker feature value d. Further, in a case where the recording of the voice of the original speaker is skipped on the UI screen of FIG. 7(B), the speaker feature value synthesis processing is skipped, and the speaker feature value dₐᵥₐₜₐᵣ extracted from the avatar image a is set as the speaker feature value d.

Then, as shown in FIG. 7(C), as a third step, a state in which the avatar is uttering a sample voice can be confirmed. The voice quality converter 104 is the decoder G including a learned model and generates a sample voice into which the sample voice c of the speaker is converted to have the voice quality G(c, d) matching the impression of the avatar image a. When the user likes the sample voice, the user presses the “enter” button to settle the avatar image and the speaker feature value d acquired in FIGS. 7(A) and 7(B). Further, when the user does not like the sample voice, the user presses a “return” button and performs the above UI operation again from the beginning.

Note that, the description has been made on the assumption that the voice quality conversion device 100 configured by using a learned model is mounted in the edge device. However, the same applies to a case where the voice quality conversion device is mounted on the cloud. In this case, the edge device may access the cloud by using, for example, a browser function to display a browser screen having the UI components in FIG. 6 or 7 and perform a screen operation similar to the above.

Alternatively, only the input operation on the UI screen in FIG. 6 or 7 may be performed in the edge device, then data input in the edge device may be transmitted to a server on the cloud, and the speaker feature value extraction processing and the voice quality conversion processing based on the extracted speaker feature value may be performed in the server according to the input data.

### INDUSTRIAL APPLICABILITY

The present disclosure has been described in detail with reference to the specific embodiments. However, it is obvious that those skilled in the art can make modifications and substitutions of the embodiments without departing from the scope of the present disclosure.

There are more opportunities to create and use an avatar image of a user in the metaverse and the like, and the present disclosure can be applied to each opportunity to generate a voice matching an impression of an unknown avatar image and adjust the voice to have a voice quality individualized to a voice quality of the user according to the preference. Note that the avatar is generally defined as a character that is a virtual self of the user and may be a figure imitating the user himself/herself, but the present disclosure is not necessarily limited thereto. The avatar may have a gender different from a real user or may be a character, creature, icon, object, two-dimensional or three-dimensional animation, CG, or the like. Further, in the present specification, the embodiments in which the present disclosure is applied to voice processing (voice quality conversion and voice generation) of an avatar has been mainly described. However, the present disclosure can also be widely applied to voice processing for characters in animations and games.

In short, the present disclosure has been described in an illustrative manner, and the contents disclosed in the present specification should not be interpreted in a limited manner. To determine the subject matter of the present disclosure, the claims should be taken into consideration.

Note that the present disclosure may also have the following configurations.

(1) A voice processing device including:
an extraction unit that extracts a feature value of an avatar image; and
a processing unit that processes a voice uttered by the avatar image on the basis of the extracted feature value.

(2) The voice processing device according to (1), in which
the extraction unit extracts the feature value of the avatar image by using a feature value extractor designed such that a feature value extracted from a voice and a feature value extracted from an avatar image created from a face image of a speaker who has uttered the voice share a same feature value space and are close feature values on the space or a speaker feature value extractor designed such that a feature value extracted from a face image and a feature value extracted from an avatar image generated from the face image share a same feature value space and are close feature values on the space.

(3) The voice processing device according to (2), in which
the processing unit converts a voice quality of an input voice on the basis of the feature value in the feature value space or synthesizes a voice on the basis of the feature value in the feature value space.

(4) The voice processing device according to any one of (2) and (3), in which:
the extraction unit determines the feature value by using both the feature value extracted from the voice of the speaker and the feature value extracted from the avatar image or determines the feature value by using both the feature value extracted from the face image of the speaker and the feature value extracted from the avatar image.

(5) The voice processing device according to any one of (1) to (4), in which
the extraction unit extracts the feature value by using a feature extractor configured by a model learned by using a data set including a voice, a face image of a speaker who has uttered the voice, and an avatar image generated from the face image.

(6) The voice processing device according to any one of (1) to (4), in which
the extraction unit describes a voice, a face image of a speaker who has uttered the voice, and an avatar image generated from the face image by a common impression word and uses the common impression word as the feature value.

(7) A voice processing method including:
an extraction step of extracting a feature value of an avatar image; and
a processing step of processing a voice uttered by the avatar image on the basis of the extracted feature value.

(8) An information terminal including:
a first input unit that inputs first data for creating an avatar image;
a second input unit that inputs second data for adjusting a voice of the avatar image; and
a processing unit that processes the voice of the avatar image on the basis of a feature value determined by using both a feature value extracted from the avatar image created on the basis of the first data and a feature value extracted from a voice of a speaker based on the second data.

(9) An information processing device including:
a first model that extracts a feature value of an avatar image;
a second model that converts a voice quality of a voice of the avatar image or performs voice synthesis on the basis of the feature value extracted by the first model; and
a learning unit that learns the first model and the second model by using a data set including at least two of a voice, a face image of a speaker who has uttered the voice, or an avatar image generated from the face image.

(10) The information processing device according to (9), in which
the learning unit learns the first model and the second model by adversarial learning such that a discriminator that discriminates authenticity of a voice cannot discriminate the authenticity and a determiner that identifies a speaker of the voice cannot identify the speaker.

(11) A computer program written in a computer-readable format to cause a computer to function as:
an extraction unit that extracts a feature value of an avatar image; and
a processing unit that processes a voice uttered by the avatar image on the basis of the extracted feature value.

### REFERENCE SIGNS LIST

100 Voice quality conversion device
101 Avatar speaker feature value extractor
102 Speaker feature value extractor
103 Feature value synthesis unit
104 Voice quality converter
200, 300 Learning system
400 Voice quality conversion device
401 Avatar speaker feature value extractor
402 Speaker feature value extractor
403 Feature value synthesis unit
404 Voice synthesizer

1. A voice processing device comprising:
an extraction unit that extracts a feature value of an avatar image; and
a processing unit that processes a voice uttered by the avatar image on a basis of the extracted feature value.

2. The voice processing device according to claim 1, wherein
the extraction unit extracts the feature value of the avatar image by using a feature value extractor designed such that a feature value extracted from a voice and a feature value extracted from an avatar image created from a face image of a speaker who has uttered the voice share a same feature value space and are close feature values on the space or a speaker feature value extractor designed such that a feature value extracted from a face image and a feature value extracted from an avatar image generated from the face image share a same feature value space and are close feature values on the space.

3. The voice processing device according to claim 2, wherein
the processing unit converts a voice quality of an input voice on a basis of the feature value in the feature value space or synthesizes a voice on a basis of the feature value in the feature value space.

4. The voice processing device according to claim 2, wherein:
the extraction unit determines the feature value by using both the feature value extracted from the voice of the speaker and the feature value extracted from the avatar image or determines the feature value by using both the feature value extracted from the face image of the speaker and the feature value extracted from the avatar image.

5. The voice processing device according to claim 1, wherein
the extraction unit extracts the feature value by using a feature extractor configured by a model learned by using a data set including a voice, a face image of a speaker who has uttered the voice, and an avatar image generated from the face image.

6. The voice processing device according to claim 1, wherein
the extraction unit describes a voice, a face image of a speaker who has uttered the voice, and an avatar image generated from the face image by a common impression word and uses the common impression word as the feature value.

7. A voice processing method comprising:
an extraction step of extracting a feature value of an avatar image; and
a processing step of processing a voice uttered by the avatar image on a basis of the extracted feature value.

8. An information terminal comprising:
a first input unit that inputs first data for creating an avatar image;
a second input unit that inputs second data for adjusting a voice of the avatar image; and
a processing unit that processes the voice of the avatar image on a basis of a feature value determined by using both a feature value extracted from the avatar image created on a basis of the first data and a feature value extracted from a voice of a speaker based on the second data.

9. An information processing device comprising:
a first model that extracts a feature value of an avatar image;
a second model that converts a voice quality of a voice of the avatar image or performs voice synthesis on a basis of the feature value extracted by the first model; and
a learning unit that learns the first model and the second model by using a data set including at least two of a voice, a face image of a speaker who has uttered the voice, or an avatar image generated from the face image.

10. The information processing device according to claim 9, wherein
the learning unit learns the first model and the second model by adversarial learning such that a discriminator that discriminates authenticity of a voice cannot discriminate the authenticity and a determiner that identifies a speaker of the voice cannot identify the speaker.

11. A computer program written in a computer-readable format to cause a computer to function as:
an extraction unit that extracts a feature value of an avatar image; and
a processing unit that processes a voice uttered by the avatar image on a basis of the extracted feature value.
